(19) United States
(12) Patent Application Publication
(10) Pub. No.: US 2005/0269756 A1
(43) Pub. Date: Dec. 8, 2005

(54) Reconfigurable clamp for a flexible manufacturing system

(76) Inventors: Robin Stevenson, Bloomfield, MI (US); Roland J. Menassa, Macomb, MI (US); Ivan G. Sears, Rochester Hills, MI (US)

Correspondence Address: General Motors Corporation, Legal Staff;Mail Code 482-CCS-B21, 300 Renaissance Center, P.O. Box 300, Detroit, MI, 48265, US

(21) Appl. No.: 11/144,261

(22) Filed: Jun. 3, 2005

Related U.S. Application Data
(60) Provisional application No. 60/577,105, filed on Jun. 4, 2004.

(51) Int. Cl. B25B 5/16

(52) U.S. Cl. 269/266

(57) ABSTRACT

Reconfigurable clamps, clamp systems are disclosed herein that are suitable for a flexible manufacturing process such as, for example, in the manufacture of automotive body panels. The reconfigurable clamp generally includes a body comprising a sleeve extending into a stationary portion and through a rotatable portion, wherein the rotatable portion includes a slot opening coaxially aligned with the sleeve, and wherein the slot opening comprises a termination point; a shaft fixedly attached to the rotatable portion; and a pin disposed in sliding engagement with the sleeve, wherein the pin comprises a head, a shaft extending from the head, and a compression spring in operative communication with the shaft and the stationary portion, wherein the shaft further comprises an engageable portion adapted to lockingly engage the termination point upon rotation of the rotatable portion.

### CROSS REFERENCE TO RELATED APPLICATIONS

This application relates to, and claims priority to, provisional U.S. Application No. 60/577,105 filed on Jun. 4, 2004, hereby incorporated by reference in its entirety.

### BACKGROUND

The present disclosure generally relates to a flexible manufacturing system for vehicle assembly, and more particularly, to a reconfigurable clamp for providing support for a variety of different body panel configurations employed in the vehicle assembly without requiring manual adjustment or reprogramming.

The advent of assembly lines has enabled rapid, mass production of products at a reduced product cost. Assembly lines typically include multiple operation stages with component, material or sub-assembly inputs. Sometimes the workpieces are similar or related part shapes. Other times, the workpieces are of unrelated design but require similar manufacturing operations. In these varied applications, the fixture reconfiguration or changeover from one part design to another has to be fast enough to meet the productivity requirements of current manufacturing systems.

Previous efforts in designing and developing flexible fixturing for either small batch manufacture or mass production scenarios can generally include the use of modular fixtures and conformable fixtures. Modular fixturing generally includes fixtures assembled from a standard library of elements such as V-blocks, toggle clamps, locating blocks, and the like. Their flexibility lies in the ability to be reconfigured either manually or by a robotic device. However, modular fixtures have no intrinsic ability to adapt to different sizes and shapes of parts within a part family. In addition, the time necessary for reconfiguration is long and modular fixtures generally lack stiffness. As a result, modular fixtures are more suited to a job shop environment rather than mass production.

The advent of Flexible Manufacturing Systems (FMS) in the early 1960's provided the impetus for work on conformable fixturing. A conformable fixture is defined as one that can be configured to accept parts of varying shape and size. Conformable fixture technology generally includes encapsulant or mechanistic techniques. Examples of encapsulant fixtures are found in the aerospace industry, where low melting-point metals are used to enclose turbine blades and produce well-defined surfaces for part location and clamping for grinding operations. While an excellent means of facilitating the holding of complex parts, encapsulation is a costly and time-consuming process.

Mechanistic fixtures reported in the literature include the use of petal collets, programmable conformable clamps, a programmable/multi-leaf vise, an adjustable integral fixture pallet, and the like. Of these, the adjustable integral fixture pallet concept appears to be the most capable of accommodating a part family of castings. To date, however no feasibility studies have been conducted regarding the applicability of any of these techniques to production machining operations.

One troublesome area in flexible manufacturing systems is its implementation in body shops. Clamps are typically employed to support the various sheet metal workpieces, e.g., body panels, during assembly and clamping can potentially scratch the exposed surface and/or locally deform the workpiece, affecting its aesthetic quality. While, ideally, clamping could be performed on flanges or surfaces that are invisible or immaterial to end users, some clamping inevitably occurs on exposed surfaces.

Current clamps utilized in assembly lines generally include a clamp block, which accurately matches the contours of the workpiece and a matching pressure foot. In operation, the clamp block supports the exterior surface of the workpiece while the pressure foot contacts the inner (non-exposed) surface with a compliant pad shaped to approximate, in the unloaded condition, a point. With this approach, minor differences between the shape of the workpiece and the clamp block geometry can be accommodated without introducing local deformation. As a result, the contour of each clamp block is generally specific to a limited number of work pieces and surfaces. In dedicated facilities, the contours of the clamp block are generally fabricated by numerically controlled (NC) machining using data generated from the workpiece to be fixtured. A problem arises if multiple models are produced having significantly different workpiece configurations. Multiple clamp blocks having different contours are then required to accommodate the multiplicity of workpiece configurations.

Accordingly, there remains a need for a reconfigurable clamp block that can provide adequate support for a variety of workpiece configurations.

### BRIEF SUMMARY

Disclosed herein are reconfigurable clamps and clamp systems suitable for a flexible manufacturing process, for example. The reconfigurable clamp comprises a body comprising a sleeve extending into a stationary portion and through a rotatable portion, wherein the rotatable portion includes a slot opening coaxially aligned with the sleeve, and wherein the slot opening comprises a termination point; a shaft fixedly attached to the rotatable portion; and a pin disposed in sliding engagement with the sleeve, wherein the pin comprises a head, a shaft extending from the head, and a compression spring in operative communication with the shaft and the stationary portion, wherein the shaft further comprises an engageable portion adapted to lockingly engage the termination point of the slot opening upon rotation of the rotatable portion.

The reconfigurable clamp systems comprises a support comprising a body comprising a sleeve extending into a stationary portion and through a rotatable portion, wherein the rotatable portion includes a slot opening coaxially aligned with the sleeve, and wherein the slot opening comprises a termination point; a shaft fixedly attached to the rotatable portion; and a pin disposed in sliding engagement with the sleeve, wherein the pin comprises a head, a shaft extending from the head, and a compression spring in operative communication with the shaft and the stationary portion, wherein the shaft further comprises an engageable portion adapted to lockingly engage the termination point upon rotation of the rotatable portion; and a member in operative communication with the support.

A process for clamping a workpiece comprises loading a first workpiece onto a reconfigurable clamp, wherein the reconfigurable clamp comprises a support comprising a body comprising a sleeve extending into a stationary portion and through a rotatable portion, wherein the rotatable portion includes a slot opening coaxially aligned with the sleeve, and wherein the slot opening comprises a termination point; a shaft fixedly attached to the rotatable portion; and a pin disposed in sliding engagement with the sleeve, wherein the pin comprises a head, a shaft extending from the head, and a compression spring in operative communication with the shaft and the stationary portion, wherein the shaft further comprises an engageable portion adapted to lockingly engage the termination point upon rotation of the rotatable portion; compressing the pin to conform substantially to a surface contour of the first workpiece; rotating the rotatable portion in an amount and direction effective to cause the engageable portion to lockingly engage the termination point; and applying controlled pressure through a member to a backside of the first workpiece.

The above described and other features are exemplified by the following figures and detailed description.

### BRIEF DESCRIPTION OF THE DRAWINGS

Referring now to the figures, which are exemplary embodiments and wherein the like elements are numbered alike:

FIG. 1 is cross sectional view of a rotary reconfigurable clamp block taken along lines 1-1 of FIG. 2;

FIG. 2 is an end on view of a rotatable disc disposed in the rotary reconfigurable clamp block; and

FIGS. 3-7 schematically illustrate a rotary reconfigurable clamp system at various stages of a process sequence employing the reconfigurable clamp taken along lines 3-3 of FIG. 2.

### DETAILED DESCRIPTION

Disclosed herein are a reconfigurable clamp, reconfigurable clamp system, and process for providing support and securement of a variety of dissimilar workpieces. Although, reference will be made to its use in fixturing automotive body panels, it should be understood that the reconfigurable clamp, reconfigurable clamp system, and process could be employed for a variety of end use applications where it may be desirable to support dissimilar workpieces with the clamp without requiring the manual adjustment or reprogramming or the clamp replacement that is generally performed to accommodate the different configurations of workpieces. For example, the reconfigurable clamp system and the various components thereof can be employed in flexible manufacturing systems for thin walled and/or thick walled objects, contoured and/or planar objects, on exterior surfaces as well as hidden surfaces, and the like. Advantageously, the reconfigurable clamp system can be used on exposed surfaces of body panels without marring, scratching, and/or causing local deformations. The following description of preferred embodiments is merely exemplary in nature and is in no way intended to limit the disclosure, its application, or uses.

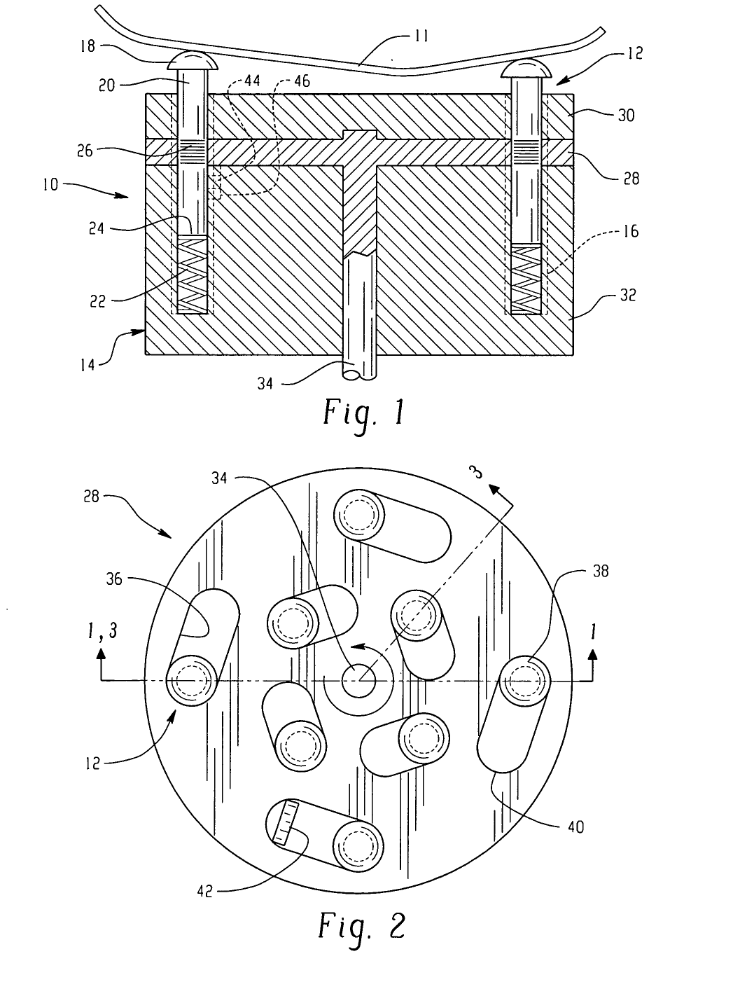

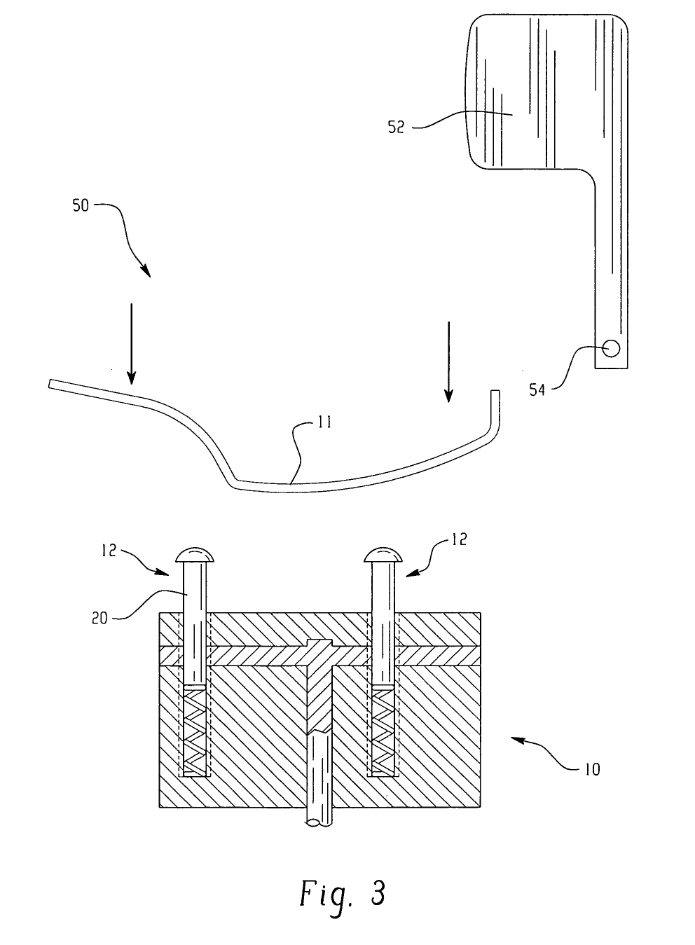

Referring now to FIGS. 1 and 2, there is shown an exemplary reconfigurable clamp, generally designated by reference numeral 10, which is suitable for use in the reconfigurable clamp system. As will be appreciated by those skilled in the art in view of this disclosure, the reconfigurable clamp and/or system is well suited for integration with flexible manufacturing systems. The reconfigurable clamp system generally includes a matching pressure foot (see FIGS. 3-7) for clamping workpieces 11 during manufacturing. Advantageously, the reconfigurable clamp and/or system can be employed to accommodate a variety of different product types. In this manner, significant savings can be obtained by reducing design, engineering, manufacturing, and purchasing of clamp blocks for each product type, e.g., dissimilar body panels.

The reconfigurable clamp 10 generally includes a reconfigurable contact portion, which eliminates the need for manual adjustment and reprogramming during changeovers. The reconfigurable contact portion comprises a plurality of spring-loaded pins 12 mounted within a body 14 for contacting workpiece 11. As will be discussed in greater detail below, the spring-loaded pins 12 can be vertically adjusted to a fixed height relative to the body. In this manner, upon loading a workpiece onto the contact portion the spring-loaded pins can conform to a contoured surface thereon and subsequently lock in place to provide a stable conformal support to the workpiece. As shown in FIG. 2, there are eight spring-loaded pins 12. The disclosure is not intended to be limited to the eight pins as shown. More or fewer pins can be employed depending on the desired application. Likewise, the spatial arrangement of the pins within the cylindrical body is not intended to be limited.

Each spring-loaded pin 12 is disposed in a corresponding cylindrically shaped sleeve 16 within the body 14, wherein each pin 12 is independently vertically adjustable therein. The sleeves 16 are dimensioned to permit vertical motion of the pins 12, yet restrain or minimize lateral motion. Each pin 12 includes a head 18 and a shaft 20 extending from the head 18. A compression spring 22 is in operative communication with a free end 24 of the pin shaft 20 and the body 14 to provide vertical motion to the pin 12 upon application of a load or force upon the pin, assuming, of course, that the pin 12 is not in a locked position. The spring constants of the compression springs 22 are optimized for the various workpieces to permit a desired amount of displacement. The head 18 is illustrated as having a generally convex surface and as will be described in greater detail below, is the point of contact between the clamp block 10 and the workpiece 11 to be supported and clamped. Other shaped head surfaces are contemplated so long as slot interference of the pin 12 can occur upon rotation of the rotatable disc. In one embodiment, the diameter of the head 18 is greater than the diameter of the sleeve 16.

The shaft 20 further includes an engageable portion 26 that is substantially aligned with a rotatable portion (e.g., a disc) 28 of the body 14. The engageable portion 26 includes engagement means with the rotatable portion 28 for locking the vertical position of the pin 12 during use. That is, the engageable portion 26 is located on the pin shaft 20 at a location such that rotation of the rotatable portion 28 can result in a locking engagement between the rotatable portion and the engageable portion, thereby providing a means for locking the pin 12 at a particular vertical height. Optionally, the engageable portion 26 can extend along the entire length of the pin and in some embodiments, may be limited to only a surface of the pin that contacts the rotatable portion 28 upon rotation thereof.

The pins 12 are fabricated from a material having sufficient strength to sustain, without undergoing permanent deformation, the mass of the given workpiece 11 and the applied clamp load. In one embodiment, the pinheads 18 are formed or coated with a low durometer material such as a polymer. Suitable polymers include thermoplastic resins and thermoset resins. Non-limiting examples include polyurethanes, rubbers, and the like, among others. In one embodiment, a sheet of the low durometer material is draped or disposed over the pins. In this embodiment, the thickness of the sheet can be defined by the spacing between adjacent pinheads, wherein the thickness is slightly less than the spacing. In other embodiments, the pins are individually covered and/or coated with the low durometer material.

The body 14, which includes the rotatable portion 28, further includes stationary portions 30, 32. The rotatable portion rotates relative to the stationary portions 30, 32. Although reference is made to two stationary portions, more or fewer stationary portions can be employed as should be appreciated by those skilled in the art. Likewise, the rotatable portion can be intermediate the stationary portions as shown or may form the bottommost or uppermost layer.

A shaft 34 is axially coupled to the rotatable portion 28 and is in operative communication with a device, e.g., a solenoid or air cylinder-actuated rack and pinion mechanism or a motor (not shown), e.g., an air driven motor, for providing the desired direction of rotation to the rotatable portion 28 with respect to the stationary portions 30, 32. In the illustrated embodiment, the upper stationary portion 30 may further include a bearing (not shown) that is adapted to receive one end of the shaft 34. Although the body 14 is illustrated as having a cylindrical shape, other shapes are contemplated.

As shown more clearly in FIG. 2, the rotatable portion 28 comprises a plurality of slot openings 36, wherein each one of the slot openings 36 is aligned with the sleeves 16 and accommodates each one of the spring-loaded pins 12. The slot openings 36 are configured to permit rotation of the rotatable portion 28 about a central axis thereof except when the rotatable portion is at the limits of rotation, which are generally defined by termination points 38, 40 of a particular slot opening 36. At the limit of the rotation, a selected one of the termination points 38, 40 becomes engaged with the engageable portion 26 of a respective pin 12. One or both termination points (38 and/or 40) can be configured to become engaged with the engageable portion 26 upon contact therewith.

Upon engagement, the pin 12 is prevented from further vertical movement. In this manner, the spring-loaded pins 12 can be locked into position fixing their vertical height. In contrast, in the unlocked position, the springs can compress upon loading of the workpiece 11 onto the clamp 10 (allowing the pins to move vertically). Thus, the pins automatically adjust to the contours of the workpiece 11 without the need for manual intervention or programming. Once the workpiece 11 is loaded, the pins 12 can be locked into their vertical positions by rotation of rotatable portion 28, thereby maintaining secured contact with the workpiece 11 upon clamping with a pressing member such as a matching pressure foot, which pressingly contacts the “other side” of the workpiece 11 and thereby forces it against the clamp.

As previously noted, the engageable portion 26 provides a means for selectively locking the pin 12 against further vertical movement. The engageable portion 26 can comprise a threaded shaft portion aligned in operative communication with the rotatable portion 28 as shown, a serrated portion, an indentation, or like configurations that become lockingly engaged with a rotatable disc upon contact with termination points 38, 40 (See FIG. 2). Because of this, it is desirable that termination points, 38, 40, have geometries that are complementary to the geometry of the engageable portion 26 so as to permit selective engagement.

Alternatively, a stop 42, formed of a compliant material that will adopt such a complementary geometry when driven into engageable portion 26 by rotation of the rotatable portion 28 such as by motor torque, may be used.

In another embodiment, a stop 44 may be provided along the shaft of the pin to prevent unrestrained retraction or extension of the spring-loaded pins. The stop 44 may be in operative communication with shoulders formed in a recess 46 formed in the shaft sleeve 16, e.g., formed in the stationary portion.

In one embodiment, the slot-pin interference mechanism described above occurs unidirectionally. That is, the range of motion of the rotatable disc 16 is limited either by a stop on the body 14 (dimension of the slot openings 36) or by limitation of the rotational range of the motor.

In another embodiment, the body 14 is gimbal mounted onto a suitable robotic arm or the like to permit a range of workpiece-angular orientations relative to the fixture while still maintaining an approach direction approximately parallel to the direction of pin displacement

FIGS. 3-7 schematically illustrate a reconfigurable clamp system 50 at various stages of a process sequence employing the rotary and reconfigurable clamp 10. In FIG. 3, a workpiece 11, e.g., an automotive body panel, is shown being loaded in the direction indicated by arrows onto the reconfigurable clamp 10. A matching pressure foot 52, which pivots about pivot point 54 is in a retracted position to enable loading. The mass of the workpiece 11 compresses and displaces the spring-loaded pins 12 such that all pins are in contact with the workpiece 11. Because the pins are spring-loaded, the pins collectively conform to the workpiece surface in the manner previously described. Once stabilized, a motor is actuated to rotate the rotatable (slotted) disc in an amount effective to lockingly engage the pins against the termination points 38, 40 (and/or stops 42) and lockingly maintain the pin 12 at the fixed vertical position determined by the workpiece load, even when additional loads are exerted such as may occur upon clamping by the pressure foot or upon workpiece processing, e.g., welding operations, and the like.

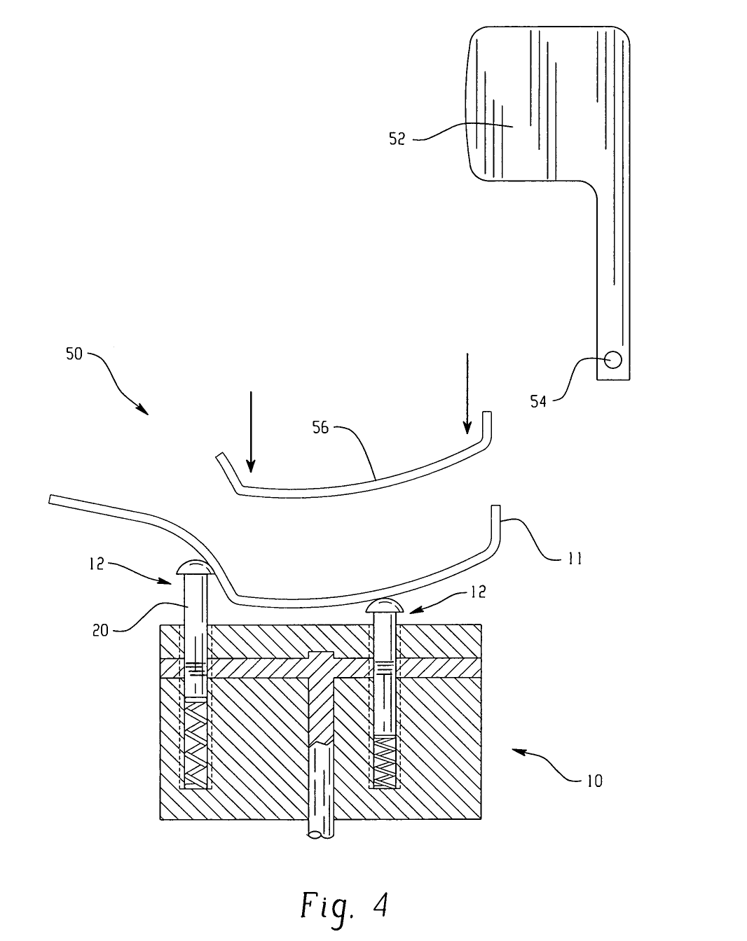

In FIG. 4, workpiece 11 is shown fully seated onto the clamp 10 causing the pins 12 therein to compress against the compression springs such that the pins conform to the part geometry. Once the workpiece 11 is loaded, the pins are locked in place by slot interference caused by rotation of the clamp. The pressure foot 52 remains in the retracted position to enable loading of a second workpiece 56, e.g., a reinforcement panel or the like. By way of example, the second workpiece, e.g., the reinforcement panel 56 can be designed to self-locate by closely conforming to the matching contours of workpiece 11.

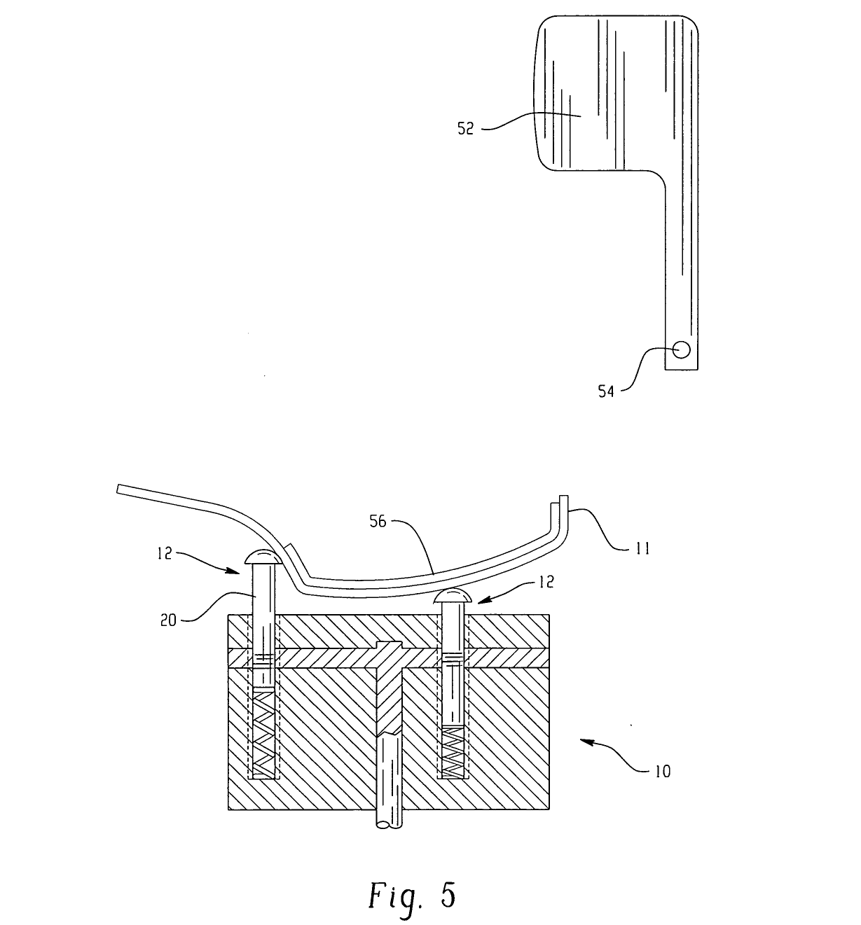

In FIG. 5, the second workpiece 52 is shown seated against workpiece 11.

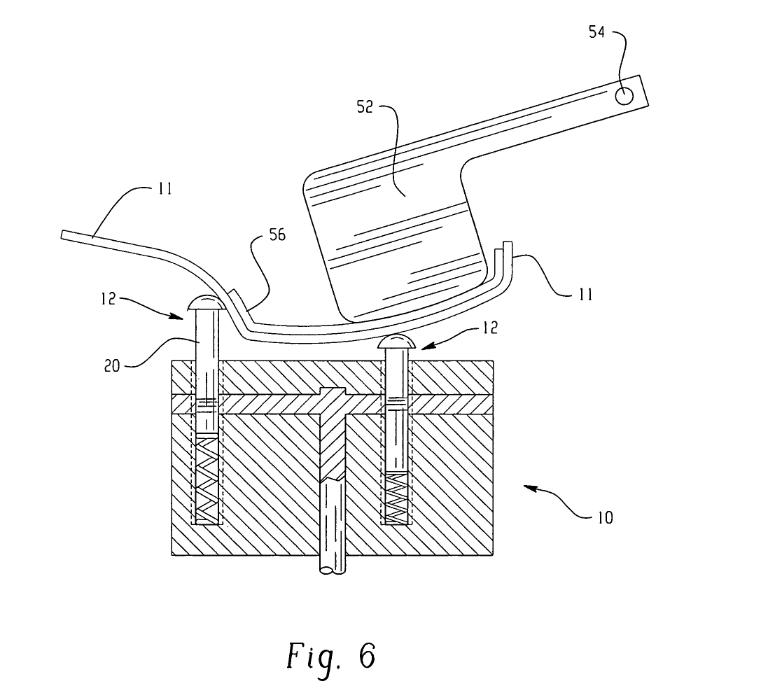

In FIG. 6, the matching pressure foot 52 pivots about the pivot point 54 to clamp workpiece 11 and the second workpiece 56 against the reconfigurable clamp 10. In one embodiment, the pressure foot 52 has a contact surface formed of a compliant material so as to deform upon contact with workpiece 11, thereby providing greater surface contact upon clamping.

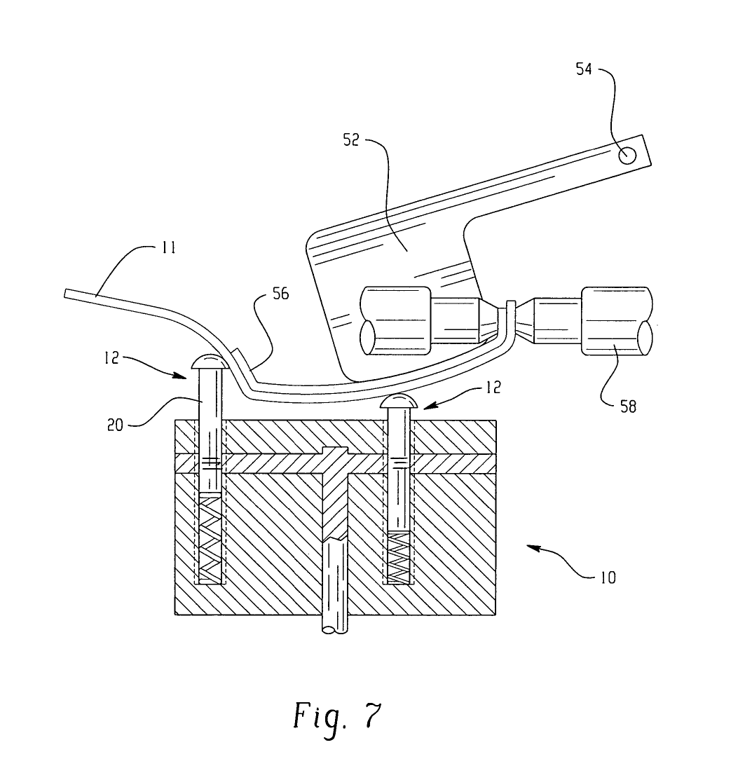

In FIG. 7, a pair of (resistance spot) welding electrode tips 58 attached to a welding gun (not shown) are moved into position to weld the second workpiece 56 to workpiece 11. For automotive body panel operations, the welds are preferably along a flange. The welding electrode tips 58 may be located along any part of the common flange length, where it does not interfere with the pressure foot 50 and clamp 10. Although reference has been made to welding operations, other processing equipment can be employed.

At the conclusion of the weld(s), the welding electrode tips 58 are removed and the matching pressure foot 52 is pivoted to a retracted position. The assembled workpiece 11, 56 is then removed from the fixture and advanced to the next station.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A reconfigurable clamp, comprising:
a body comprising a sleeve extending into a stationary portion and through a rotatable portion, wherein the rotatable portion includes a slot opening coaxially aligned with the sleeve, and wherein the slot opening comprises a termination point;
a shaft fixedly attached to the rotatable portion; and
a pin disposed in sliding engagement with the sleeve, wherein the pin comprises a head, a shaft extending from the head, and a compression spring in operative communication with the shaft and the stationary portion, wherein the shaft further comprises an engageable portion adapted to lockingly engage the termination point upon rotation of the rotatable portion.

2. The reconfigurable clamp of claim 1, wherein the body comprises a plurality of pins spatially located therein, wherein each one of the plurality of pins is in sliding engagement with a selected one of a plurality of sleeves.

3. The reconfigurable clamp of claim 2, wherein the pin further comprises a protrusion extending from each one of the plurality of pins and wherein each one of the plurality of sleeves comprises a recess adapted to receive the protrusion and permit a limited amount of displacement to the plurality of pins.

4. The reconfigurable clamp of claim 1, further comprising a motor coupled to the shaft.

5. The reconfigurable clamp of claim 1, wherein the engageable portion comprises a serrated portion and the termination point comprises a complementary geometry.

6. The reconfigurable clamp of claim 1, wherein the body has at least one gimbaled surface.

7. The reconfigurable clamp of claim 1, wherein the engageable portion extends along a length of the shaft.

8. The reconfigurable clamp of claim 7, wherein the engageable portion extends along a portion of length of the shaft.

9. The reconfigurable clamp of claim 1, wherein the head further comprises a polymeric coating disposed thereon.

10. The reconfigurable clamp of claim 1, wherein the head has a diameter greater than a shaft diameter.

11. The reconfigurable clamp of claim 1, wherein the sleeve is dimensioned to prevent lateral movement of the pin.

12. The reconfigurable clamp of claim 1, wherein the termination point comprises a compliant material adapted to conform to the engageable portion upon contact therewith.

13. A reconfigurable clamp system, comprising:
a support comprising a body comprising a sleeve extending into a stationary portion and through a rotatable portion, wherein the rotatable portion includes a slot opening coaxially aligned with the sleeve, and wherein the slot opening comprises a termination point; a shaft fixedly attached to the rotatable portion; and a pin disposed in sliding engagement with the sleeve, wherein the pin comprises a head, a shaft extending from the head, and a compression spring in operative communication with the shaft and the stationary portion, wherein the shaft further comprises an engageable portion adapted to lockingly engage the termination point upon rotation of the rotatable portion; and
a member in operative communication with the support.

14. The reconfigurable clamp system of claim 13, wherein the body comprises a plurality of pins spatially located therein, wherein each one of the plurality of pins is in sliding engagement with a selected one of a plurality of sleeves.

15. The reconfigurable clamp of claim 13, wherein the engageable portion comprises a serrated portion and the termination point comprises a complementary geometry.

16. The reconfigurable clamp of claim 13, wherein the sleeve is dimensioned to prevent lateral movement of the pin.

17. The reconfigurable clamp of claim 13, wherein the termination point comprises a compliant material adapted to conform to the engageable portion upon contact therewith.

18. A process for clamping a workpiece, the process comprising:
loading a first workpiece onto a reconfigurable clamp, wherein the reconfigurable clamp comprises a support comprising a body comprising a sleeve extending into a stationary portion and through a rotatable portion, wherein the rotatable portion includes a slot opening coaxially aligned with the sleeve, and wherein the slot opening comprises a termination point; a shaft fixedly attached to the rotatable portion; and a pin disposed in sliding engagement with the sleeve, wherein the pin comprises a head, a shaft extending from the head, and a compression spring in operative communication with the shaft and the stationary portion, wherein the shaft further comprises an engageable portion adapted to lockingly engage the termination point upon rotation of the rotatable portion;
compressing the pin to conform substantially to a surface contour of the first workpiece;
rotating the rotatable portion in an amount and direction effective to engage the engageable portion with the termination point; and
applying a member to a backside of the first workpiece.

19. The process of claim 18, further comprising removing the member;
rotating the rotatable portion in an amount and direction effective to disengage the engageable portion from the termination point; and removing the first workpiece from the reconfigurable clamp.

20. The process of claim 18, further comprising loading a second workpiece onto the reconfigurable clamp, wherein the second workpiece has a different surface contour than the first workpiece; compressing the pin to conform substantially to a surface contour of the second workpiece; rotating the rotatable portion in an amount and direction effective to cause the engageable portion to lockingly engage the termination point; and applying a member to a backside of the surface of the second workpiece.

21. The process of claim 18, wherein the body comprises a plurality of pins spatially located therein, wherein each one of the plurality of pins is in sliding engagement with a selected one of a plurality of sleeves.
